(19) United States
(12) Patent Application Publication
(10) Pub. No.: US 2022/0403159 A1
(43) Pub. Date: Dec. 22, 2022

(54) Thermoplastic Polymer Composition With Increased Electrical Tracking Resistance and Polymer Articles Made Therefrom

(71) Applicant: Celanese International Corporation, Irving, TX (US)

(72) Inventors: Qamer Zia, Raunheim (DE); Kirsten Markgraf, Weinheim (DE); Dirk Zierer, Hattersheim (DE); Patrick Nickolay, Villmar (DE)

(21) Appl. No.: 17/834,372

(22) Filed: Jun. 7, 2022

Related U.S. Application Data
(60) Provisional application No. 63/197,695, filed on Jun. 7, 2021.
(60) Provisional application No. 63/341,605, filed on May 13, 2022.

(51) Int. Cl. C08L 67/02; C08J 5/24

(52) U.S. Cl. CPC C08L 67/02; C08J 5/248; C08L 2205/025; C08L 2205/035; C08J 2367/02; C08J 2467/02; C08J 2479/08; C08J 2433/12

(57) ABSTRACT

Halogen-free, flame resistant and hydrolysis resistant polymer compositions are disclosed. The polymer composition of the present disclosure is also formulated to have improved electrical tracking resistance. The polymer composition contains a thermoplastic polymer, such as polybutylene terephthalate. The thermoplastic polymer is combined with a flame retardant that can include a phosphinate optionally in combination with a phosphite and/or a nitrogen-containing synergist. In order to improve electrical tracking resistance, one or more electrical resistance agents are added to the polymer composition. The electrical resistance agent, for instance, can be a flexible polymer.

### RELATED APPLICATIONS

The present application is based upon and claims priority to U.S. Provisional Patent Application Ser. No. 63/197,695, having a filing date of Jun. 7, 2021 and U.S. Provisional Patent Application Ser. No. 63/341,605, having a filing date of May 13, 2022, both of which are incorporated herein by reference.

### BACKGROUND

Engineering thermoplastics are often used in numerous and diverse applications in order to produce molded parts and products. For instance, polyester and polyamide polymers are used to produce all different types of molded products, such as injection molded products, blow molded products, and the like. Polyester polymers, for instance, can be formulated in order to be chemically resistant, to have excellent strength properties and, when formulating compositions containing polyester elastomers, to be flexible. Of particular advantage, polyester polymers can be melt processed due to their thermoplastic nature. In addition, polyester polymers can be recycled and reprocessed.

One problem faced by those skilled in the art in producing molded parts and products from thermoplastic polymers is the ability to make the articles flame resistant. Although almost a limitless variety of different flame retardants are marketed and sold commercially, selecting an appropriate flame retardant for a particular thermoplastic polymer composition is difficult and unpredictable. Further, many available flame retardants contain halogen compounds, such as bromine compounds, which can produce harsh chemical gases during production.

Another problem faced by those skilled in the art in producing molded parts and products from polyester polymers is the ability to make the articles hydrolysis resistant. Many polyester polymers, for instance, are known to degrade when subjected to repeated contact with water or high humidity environments, especially at elevated temperatures.

One area where flame resistance and hydrolysis resistance are needed, for instance, is when using thermoplastic polymers to design and produce connectors, particularly high-voltage connectors. High-voltage connectors are designed to make a detachable electrical connection with high-voltage components, such as components that make up the electrical drive system of a motor vehicle. High-voltage connectors, for instance, are particularly high in demand due to the evolution of hybrid vehicles, electrical vehicles, and fuel cell vehicles.

Modern electrical drive systems of electric vehicles, for instance, include numerous high-voltage components or assemblies where the high-voltage devices operate at voltages of greater than 300 V. These include in particular power control elements, such as inverters, current converters and/or power converters, a control unit, and/or electronic controller units.

The high-voltage connectors are designed to operate in high-voltage environments while providing protection against electrical shock. These connectors may also need to operate at high temperatures and in high humidity environments. Thus, connector housings need to be flame retardant and hydrolysis resistant.

In many applications, however, when measures are taken in order to increase flame resistance or hydrolysis resistance, the electrical insulation properties of the polymer can be degraded. In fact, there is great demand for increasing the electrical resistance of thermoplastic polymers without affecting other properties of the polymer composition. The present disclosure is directed to a thermoplastic polymer composition having an improved combination of flame retardant properties, hydrolysis resistance, and electrical tracking resistance.

### SUMMARY

In general, the present disclosure is directed to a polymer composition containing a thermoplastic polymer, such as a polyester polymer, in conjunction with a fire retardant composition and at least one electrical resistance agent. The components of the fire retardant composition are carefully selected in order to produce a polymer composition having improved fire resistant properties. For example, the polymer composition can display a V-0 rating at a thickness of 1.6 mm or at 0.8 mm when tested according to Underwriters Laboratories Test 94. In addition, the polymer composition can display hydrolysis resistant tensile-mechanical and impact properties when subjected to a Hydrolysis Test at 121° C. For instance, the polymer composition can be formulated such that the tensile properties of the composition, such as the tensile modulus, does not decrease by more than about 50% when tested for 168 hours.

In one embodiment, for instance, the present disclosure is directed to a flame resistant polymer composition that contains a thermoplastic polymer, such as a polyester polymer. The polyester polymer can be present in the polymer composition generally in an amount greater than about 35% by weight, such as in an amount greater than about 40% by weight, such as in an amount greater than about 45% by weight. The polyester thermoplastic polymer may be a polybutylene terephthalate polymer. In one embodiment, a hydrolysis resistant polyester polymer, such as a hydrolysis resistant polybutylene terephthalate polymer may be used. The polyester polymer (e.g. polybutylene terephthalate polymer) can contain a limited amount of carboxyl end groups. The polyester polymer may contain carboxyl end groups in an amount less than about 20 mmol/kg.

In accordance with the present disclosure, the thermoplastic polymer is combined with a non-halogen flame retardant composition comprising a metal phosphinate, optionally a metal phosphite and optionally a nitrogen-containing synergist. The metal phosphite, for instance, may comprise aluminum phosphite having the following formula: Al₂(HPO₃)₃. The metal phosphinate, on the other hand, may be a dialkyl phosphinate, such as aluminum diethyl phosphinate. The nitrogen-containing synergist can comprise a melamine, such as melamine cyanurate. In one aspect, the metal phosphinate is present in the polymer composition in an amount from about 5% to about 30% by weight, such as from about 7% to about 25% by weight, such as in an amount from about 7% to about 19% by weight. The metal phosphite can be present in the polymer composition generally in an amount from about 0.01% to about 4% by weight, such as from about 0.1% to about 2% by weight, such as from about 0.2% to about 1.1% by weight. The nitrogen-containing synergist, on the other hand, can be present in the polymer composition generally in an amount from about 0.01% to about 12% by weight, such as from about 2% to about 9% by weight, such as from about 3% to about 8.5% by weight.

In accordance with the present disclosure, the polymer composition also contains one or more electrical resistance agents. For example, the at least one electrical resistance agent can comprise a silicone, a polyester elastomer, a methacrylate butadiene styrene polymer, or mixtures thereof. One or more electrical resistance agents can be present in the polymer composition generally in an amount less than about 10% by weight, such as in an amount from about 0.3% to about 5% by weight. In one embodiment, the electrical resistance agent can be an ultra-high molecular weight silicone. The ultra-high molecular weight silicone can be a polydimethylsiloxane. In one aspect, the ultra-high molecular weight silicone can be present in the polymer composition in combination with a second electrical resistance agent comprising a polyester elastomer, such as a copolyester elastomer. The silicone and copolyester elastomer can be added to the polymer composition at a weight ratio of from about 3:1 to about 1:3, such as from about 2:1 to about 1:1.5.

In an alternative embodiment, the electrical resistance agent can be a polyester elastomer. The polyester elastomer, for instance, can be a thermoplastic copolyester elastomer. For example, in one embodiment, the thermoplastic copolyester elastomer can be a block copolymer of polybutylene terephthalate and polyether segments. Alternatively, the copolyester elastomer can be a thermoplastic ester ether elastomer. In one embodiment, the polymer composition can contain a polyester elastomer in combination with a second electrical resistance agent. The second electrical resistance agent can be a methacrylate butadiene styrene polymer. The methacrylate butadiene styrene polymer can have a core and shell structure.

Adding one or more electrical resistance agents to the polymer composition can dramatically improve the electrical tracking resistance of the composition and of articles made from the composition. For example, the polymer composition and articles made from the composition can have a comparative tracking index of at least 475 V, such as at least 500 V, such as at least 525 V, such as at least 550 V, such as at least 575 V, such as at least 600 V. The comparative tracking index is generally less than about 950 V.

The polymer composition can also contain reinforcing fibers, such as glass fibers. The reinforcing fibers can generally have an average fiber length of from about 1 mm to about 5 mm, and can have an average fiber diameter of from about 8 microns to about 12 microns.

The polymer composition can also contain an organometallic compatibilizer. The organometallic compatibilizer, for instance, may be a titanate. One example of a titanate that may be used is titanium IV 2-propanolato,tris(dioctyl)phosphato-O. The organometallic compatibilizer can be present in the polymer composition generally in an amount from about 0.05% to about 2.5% by weight. The flame resistant polymer composition can also contain an ester of a carboxylic acid. For example, the ester may be formed by reacting montanic acid with a multifunctional alcohol. The multifunctional alcohol may be ethylene glycol or glycerine. The ester of a carboxylic acid can be present in the polymer composition generally in an amount from about 0.05% to about 8% by weight.

In one embodiment, the polymer composition can also contain a carbodiimide, and particularly a polycarbodiimide. The polycarbodiimide, for example, can have a weight average molecular weight of 10,000 g/mol or greater.

The polymer composition of the present disclosure can have a melt flow rate of at least 3 cm³/10 min, such as greater than about 4 cm³/10 min, when tested at 250° C. and at a load of 2.16 kg.

In one embodiment, the present disclosure is directed to an electrical connector, such as a high-voltage connector, that comprises at least two opposing walls between which a passageway is defined for receiving a contact element. The contact element, for instance, can be a male conductive element or a female conductive element. In accordance with the present disclosure, the at least two opposing walls are formed from the polymer composition as described above.

Other features and aspects of the present disclosure are discussed in greater detail below.

### Definitions

As used herein, the flame resistant properties of a polymer are measured according to Underwriters Laboratories Test 94 according to the Vertical Burn Test. Test plaques can be made at different thicknesses for measuring flame resistance. A rating of V-0 indicates the best rating.

As used herein, the “Hydrolysis Test” is conducted at 121° C. by placing a test plaque in a pressure cooker for a specific length of time, such as 96 hours or 168 hours. The pressure cooker uses moist heat in the form of saturated steam under pressure. The operating range of the pressure cooker is 15 to 21 psi (using the Geared Steam Gauge). The exposure period begins when the pressure steam gauge needle registers within the above operation range (15 to 21 psi). During the test, the temperature can vary from 121° C. to 127° C. After the determined amount of time, the physical properties of the test plaque are measured and compared with initial properties.

The melt flow rate of a polymer or polymer composition is measured according to ISO Test 1133 at a suitable temperature and load, such as at 250° C. and at a load of 2.16 kg or at a load of 5 kg.

The density of a polymer is measured according to ISO Test 1183 in units of g/cm³.

Average particle size (d50) is measured using light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

Charpy impact strength at 23° C. is measured according to ISO Test 179/1eU.

The relative permittivity or dielectric constant is measured at 1 MHz and the dissipation factor is measured at 1 MHz according to IEC Test 60250.

Comparative tracking index is measured according to International Electrotechnical Commission Standard IEC-60112/3.

Dielectric Strength is determined according to IEC 60243. The thickness for the dielectric strength was 1.5 mm.

Surface/Volume Resistivity are generally determined in accordance with IEC 62631-3-1:2016 or ASTM D257-14. According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a battery pack for an electrical vehicle illustrating the top cover removed; the battery pack employing a high-voltage harness connection structure in one or more embodiments for connecting to other components of a vehicle;

FIG. 2 is a perspective view of one embodiment of a high-voltage connector in accordance with the present disclosure;

FIG. 3 is an alternative embodiment of a high-voltage connector in accordance with the present disclosure; and

FIG. 4 is an embodiment of an electric car incorporating the battery pack of FIG. 1.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a halogen-free, flame resistant polymer composition that has excellent electrical tracking resistance properties. Polymer compositions made in accordance with the present disclosure not only demonstrate superior flammability ratings when tested according to Underwriters Laboratories Tests, excellent electrical resistance properties, and are hydrolysis resistant, but also have excellent mechanical properties, including polymer processing properties.

Polymer compositions of the present disclosure are particularly well suited for high voltage applications. The polymer composition of the present disclosure, for instance, is well suited for use in constructing high voltage automotive connectors that can meet high safety standards for flammability and electrical properties as well as offer excellent hydrolysis resistance at elevated temperature. In accordance with the present disclosure, the polymer composition is formulated in order to have dramatically improved electrical tracking resistance to ensure safe and faster charging of electric vehicles. For example, polymer compositions formulated in accordance with the present disclosure can have a comparative tracking index of at least 475 V, such as at least 500 V, such as at least 525 V, such as at least 550 V, such as at least 575 V, such as at least 600 V.

The composition can also exhibit a dielectric strength of about 5 kV/mm or more, in some embodiments about 15 kV/mm or more, in some embodiments about 20 kV/mm or more, in some embodiments about 25 kV/mm or more, in some embodiments about 30 kV/mm or more, in some embodiments about 35 kV/mm or more, in some embodiments about 40 kV/mm or more, and in some embodiments about 45 kV/mm or more to about 100 kV/mm or less, in some embodiments, about 80 kV/mm or less, and in some embodiments, about 50 kV/mm or less, when measured according to IEC 60243.

The polymer composition may also exhibit a relatively high degree of electrical resistance to help provide the substrate with good insulative properties for use in the molded interconnect device. The surface resistivity may, for instance, be about 1×10¹⁴ ohms or more, in some embodiments about 1×10¹⁵ ohms or more, and in some embodiments about 1×10¹⁶ ohms or more, such as determined in accordance at a temperature of about 20° C. in accordance with IEC 62631-3-1:2016. In one aspect, the above surface resistivity characteristics can be maintained over a temperature range of from 20° C. to 120° C.

The volume resistivity may likewise be about 1×10¹¹ ohm-cm or more, in some embodiments about 1×10¹² ohm-cm or more, in some embodiments about 1×10¹³ ohm-cm or more, in some embodiments about 1×10¹⁴ ohm-cm or more, in some embodiments about 1×10¹⁵ ohm-cm or more and in some embodiments, about 1×10¹⁶ ohm-cm or more, such as determined at a temperature of about 20° C. in accordance with IEC 62631-3-1:2016. In one aspect, the above volume resistivity characteristics can be maintained over a temperature range of from 20° C. to 120° C.

In general, the polymer composition of the present disclosure contains a suitable thermoplastic polymer, such as a polybutylene terephthalate polymer, combined with a flame retardant composition that may contain a metal phosphinate alone or optionally in combination with a metal phosphite and/or a nitrogen-containing synergist. In addition to a flame retardant composition, the polymer composition can also contain reinforcing fibers. In accordance with the present disclosure, the polymer composition also contains at least one electrical resistance agent. The electrical resistance agent is added to the polymer composition in order to improve electrical tracking resistance without compromising any of the other properties. The electrical resistance agent, for instance, can be a flexible polymer, such as an elastomeric polymer. In one embodiment, at least two electrical resistance agents are added to the polymer composition for improving one or more properties.

The polymer composition of the present disclosure is particularly well suited to manufacturing electrical components, such as high-voltage electrical connectors. Electrical connectors made in accordance with the present disclosure can have a variety of configurations within the scope of the disclosure. As an example, the electrical connector can define a plurality of passageways or spaces between opposing walls. The passageways can accommodate contact elements to facilitate electrical connections. The contact elements, for instance, can be in the form of a male contact element or a female contact element for connecting with an opposing connector.

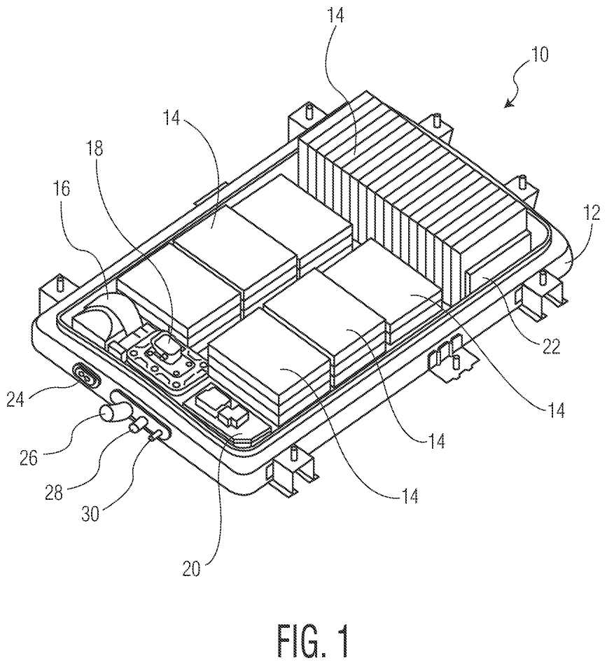

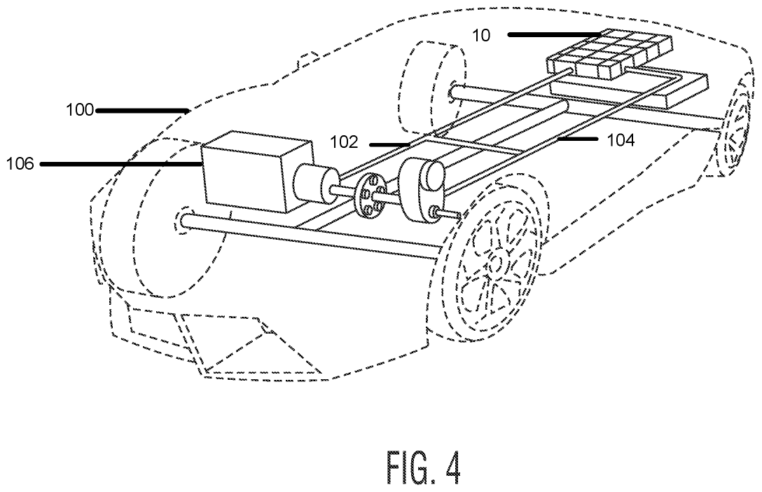

Referring to FIG. 1 and FIG. 4, for instance, one embodiment of a battery pack 10 installed in an electrical vehicle 100 is illustrated. The battery pack 10 includes a battery pack case 12. In the embodiment illustrated, only one portion of the battery pack case 12 is illustrated. The top of the battery pack case 12 has been removed in order to show the interior components.

The battery pack 10 can include a battery module 14, a temperature-adjusted air unit 16, a service disconnect switch 18 which is a high-voltage cut-off switch, a junction box 20, and a lithium ion battery controller 22.

The battery pack case 12 can be mounted in place at any suitable location within a vehicle. In order to connect the battery pack 10 to other components within a vehicle, the battery pack case 12 supports a refrigerant pipe connector terminal 24, a charging/discharging connector terminal 26, a heavy-electric connector terminal 28, and a weak electric connector terminal 30.

The battery module 14 can include a plurality of battery submodules. Each battery submodule is an assembly structure in which a plurality of battery cells are stacked on one another.

One or more high-voltage electric harnesses connect the battery pack 10 to an electric motor contained within the vehicle. For example, as shown in FIG. 4, battery pack 10 is connected to an electric motor 106 via wiring harness 102 and wiring harness 104. In addition to connectors to the battery pack 10, the electric motor of the vehicle can include converter to engine connectors, inverter to heater connectors, inverter to compressor connectors, charger to converter connectors, and the like. All of these components require connectors, particularly high-voltage connectors.

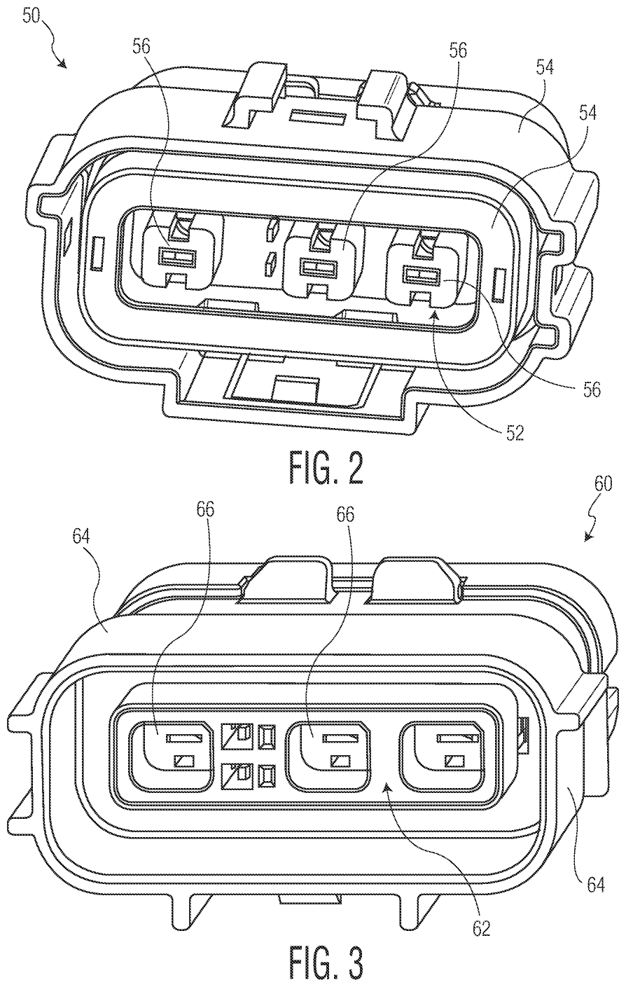

Referring to FIG. 2, one embodiment of a high-voltage connector 50 that may be made in accordance with the present disclosure is shown. The electrical connector 50 includes an insertion passageway 52 surrounded by opposing walls 54. The walls 54 accommodate a plurality of contact elements 56. The contact elements 56 are for making an electrical connection to an opposing connector. In the embodiment illustrated in FIG. 2, the contact elements 56 are male contacts that are to be inserted into opposing receptors.

Referring to FIG. 3, another connector 60 made in accordance with the present disclosure is shown. The connector 60 is for receiving and attaching to the connector 50 as shown in FIG. 2. The connector 60 includes an insertion passageway 62 surrounded by a plurality of opposing walls 64. The connector 60 includes a plurality of contact elements 66. The contact elements 66 are female connectors for receiving the male contact elements 56 from connector 50 as shown in FIG. 2.

In accordance with the present disclosure, the opposing walls 54 of the connector 50 and the opposing walls 64 of the connector 60 can be made from the polymer composition of the present disclosure. The polymer composition has excellent flame resistant properties and is also hydrolysis resistant. For example, when tested according to a Vertical Burn Test according to Underwriters Laboratories Test 94, the polymer composition can have a V-0 rating when tested at a thickness of 1.6 mm. In certain embodiments, the polymer composition can also have a rating of V-1 or V-0 when tested at a thickness of 0.8 mm. The polymer composition can display hydrolysis resistant tensile-mechanical and impact properties when subjected to a Hydrolysis Test at 121° C. For instance, the polymer composition can be formulated such that the tensile properties of the composition, such as the tensile modulus, does not decrease by more than about 50% when tested for 168 hours.

The polymer composition also has excellent mechanical properties. For instance, the tensile modulus of the polymer composition can be greater than about 8,400 MPa, such as greater than about 9,000 MPa, such as greater than about 9,500 MPa, such as greater than about 10,000 MPa, such as greater than about 10,500 MPa, such as greater than about 11,000 MPa. The tensile modulus is generally less than about 18,000 MPa. The polymer composition can have a tensile stress at break of greater than about 110 MPa, such as greater than about 112 MPa, such as greater than about 114 MPa, and generally less than about 130 MPa. The polymer composition can also have a notched Charpy impact strength of greater than about 6 kJ/m², such as greater than about 6.5 kJ/m², such as greater than about 7 kJ/m², such as greater than about 7.5 kJ/m², and generally less than about 14 kJ/m². The polymer composition can have an unnotched Charpy impact strength of generally greater than about 50 kJ/m².

As described above, the polymer composition generally contains a thermoplastic polymer and particularly a polyester polymer. The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl)ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

Polyesters that may be used in the polymer composition, for instance, include polyethylene terephthalate, polybutylene terephthalate, mixtures thereof and copolymers thereof.

In one aspect, the polyester polymer, such as the polybutylene terephthalate polymer, contains a relatively minimum amount of carboxyl end groups. For instance, the polyester polymer can contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the polyester polymer can be contacted with an alcohol, such as benzyl alcohol, for decreasing the amount of carboxyl end groups.

The polyester polymer or polybutylene terephthalate polymer can generally have a melt flow rate of greater than about 10 cm³/10 min, such as greater than about 30 cm³/10 min, such as greater than about 35 cm³/10 min, and generally less than about 100 cm³/10 min, such as less than about 80 cm³/10 min, such as less than about 60 cm³/10 min, such as less than about 50 cm³/10 min, when tested at 250° C. and at a load of 2.16 kg.

The thermoplastic polymer such as a polybutylene terephthalate polymer is present in the polymer composition in an amount sufficient to form a continuous phase. For example, the thermoplastic polymer may be present in the polymer composition in an amount of at least about 35% by weight, such as in an amount of at least about 40% by weight, such as in an amount of at least 45% by weight, such as in an amount of at least about 50% by weight, such as at least about 55% by weight. The thermoplastic polymer is generally present in an amount less than about 80% by weight.

In accordance with the present disclosure, at least one thermoplastic polymer as described above is combined with a non-halogen flame retardant composition in accordance with the present disclosure. The flame retardant composition can contain a metal phosphinate optionally in combination with a metal phosphite and/or a nitrogen-containing synergist.

The metal phosphinate, for instance, may be a dialkyl phosphinate and/or a diphosphinate. The metal phosphinate may have one of the following chemical structures:

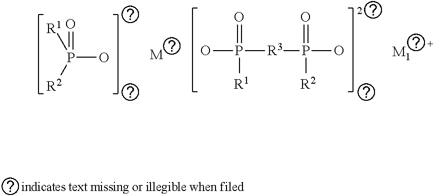

in which R¹, R² are the same or different and are each linear or branched C₁-C₆-alkyl; R³ is linear or branched C₁-C₁₀-alkylene, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

In one embodiment, the metal phosphinate is a metal dialkylphosphinate, such as aluminum diethylphosphinate. The metal phosphinate can be present in the polymer composition generally in an amount greater than about 5% by weight, such as in an amount greater than about 7% by weight, such as in an amount greater than about 9% by weight, such as in an amount greater than about 11% by weight, and generally in an amount less than about 30% by weight, such as in an amount less than about 25% by weight, such as in an amount less than about 20% by weight, such as in an amount less than about 17% by weight, such as in an amount less than about 14% by weight. In one embodiment, the metal phosphinate is present in the polymer composition in an amount from about 7% to about 19% by weight. In an alternative embodiment, the metal phosphinate is present in the polymer composition in an amount greater than about 15% by weight, such as greater than about 16% by weight, such as greater than about 17% by weight, such as greater than about 18% by weight, such as greater than about 19% by weight, such as greater than about 20% by weight, such as from about 17% by weight to about 26% by weight.

The metal phosphite that is optionally present in the polymer composition can be any suitable metal phosphite made from any of the metals (M) identified above. In one aspect, the metal phosphite is an aluminum phosphite. The aluminum phosphite can have the following chemical structure: Al₂(HPO₃)₃. Other forms of aluminum phosphite may also be present in the polymer composition. Such other forms include basic aluminum phosphite, aluminum phosphite tetrahydrate, and the like. In still another embodiment, the aluminum phosphite may have the formula: Al(H₂PO₃)₃.

The metal phosphite is believed to synergistically work with the metal phosphinate in improving the flame resistant properties of the polymer composition, especially when the polymer composition contains a polybutylene terephthalate. The weight ratio between the metal phosphinate and the metal phosphite can generally be from about 10:8 to about 30:1, such as from about 10:1 to about 20:1, such as from about 14:1 to about 18:1. In one aspect, the metal phosphite may be present in the polymer composition in an amount greater than about 0.01% by weight, such as in an amount greater than about 0.1% by weight, such as in an amount greater than about 0.2% by weight, such as in an amount greater than about 0.3% by weight, and generally in an amount less than about 4% by weight, such as in an amount less than about 2.5% by weight, such as in an amount less than about 2% by weight, such as in an amount less than about 1.1% by weight. In one embodiment, the polymer composition is free of metal phosphite and only contains metal phosphinate.

The nitrogen-containing synergist that may optionally be present in combination with the metal phosphinate can comprise a melamine. For instance, the nitrogen-containing synergist may comprise melamine cyanurate. Other melamine compounds that may be used include melamine polyphosphate, dimelamine polyphosphate, melem polyphosphate, melam polyphosphate, melon polyphosphate, and the like. Other nitrogen-containing synergists that may be used include benzoguanamine, tris(hydroxyethyl)isocyanurate, allantoin, glycoluril, guanidine, or mixtures thereof. In general, only small amounts of the nitrogen-containing synergists need to be present in the polymer composition. For instance, the nitrogen-containing synergists can be present in the polymer composition in an amount less than about 12% by weight, such as in an amount less than about 11% by weight, such as in an amount less than about 10% by weight, such as in an amount less than about 9% by weight, such as in an amount less than about 8.5% by weight, and generally in an amount greater than about 0.1% by weight, such as in an amount greater than about 2% by weight, such as in an amount greater than about 3% by weight, such as in an amount greater than about 4% by weight. In one embodiment, the polymer composition is free of nitrogen-containing synergists and only contains metal phosphinate.

The polymer composition may also contain reinforcing fibers dispersed in the thermoplastic polymer matrix. Reinforcing fibers of which use may advantageously be made are mineral fibers, such as glass fibers or polymer fibers, in particular organic high-modulus fibers, such as aramid fibers.

These fibers may be in modified or unmodified form, e.g. provided with a sizing, or chemically treated, in order to improve adhesion to the plastic. Glass fibers are particularly preferred.

The reinforcing fibers, such as the glass fibers, can be coated with a sizing composition to protect the fibers and to improve the adhesion between the fiber and the matrix material. A sizing composition usually comprises silanes, film forming agents, lubricants, wetting agents, adhesive agents, optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes.

The sizing composition applied to the reinforcing fibers can contain not only a silane sizing agent but can also contain a hydrolysis resistant agent. The hydrolysis resistant agent, for instance, can be a glycidyl ester type epoxy resin. For instance, the glycidyl ester type epoxy resin can be a monoglycidyl ester or a diglycidyl ester. Examples of glycidyl ester type epoxy resins that may be used include acrylic acid glycidyl ester, a methacrylic acid glycidyl ester, a phthalic acid diglycidyl ester, a methyltetrahydrophthalic acid diglycidyl ester, or mixtures thereof.

In one aspect, the sizing composition contains a silane, a glycidyl ester type epoxy resin, a second epoxy resin, a urethane resin, an acrylic resin, a lubricant, and an antistatic agent. The second type of epoxy resin, for instance, can be a bisphenol A type epoxy resin. The hydrolysis resistant agent can be present in the sizing composition in relation to the silane sizing agent at a weight ratio of from about 5:1 to about 1:1, such as from about 4:1 to about 2:1.

The reinforcing fibers may be compounded into the polymer matrix, for example in an extruder or kneader.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 12 μm. The length of the fibers can vary depending upon the particular application. For instance, the fibers can have an average length of greater than about 0.5 mm, such as greater than about 1 mm, such as greater than about 1.5 mm, such as greater than about 2.5 mm. The length of the fibers can generally be less than about 8 mm, such as less than about 7 mm, such as less than about 5.5 mm, such as less than about 4 mm.

In general, reinforcing fibers are present in the polymer composition in amounts sufficient to increase the tensile strength of the composition. The reinforcing fibers, for example, can be present in the polymer composition in an amount greater than about 2% by weight, such as in an amount greater than about 5% by weight, such as in an amount greater than about 10% by weight, such as in an amount greater than about 15% by weight, such as in an amount greater than about 20% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

In accordance with the present disclosure, the polymer composition contains at least one electrical resistance agent. The one or more electrical resistance agents are added to the polymer composition in order to improve electrical tracking resistance or at least one other property. The electrical resistance agent can be a polymer with elastomeric properties. Electrical resistance agents that can be used in accordance with the present disclosure include silicone polymers, polyester elastomers, methacrylate butadiene styrene polymers, and mixtures thereof. In one embodiment, a silicone polymer is added to the polymer composition in combination with a polyester elastomer. In an alternative embodiment, a polyester elastomer can be added to the polymer composition in combination with a methacrylate butadiene styrene polymer in a core and shell configuration.

When the electrical resistance agent is a silicone polymer, in one embodiment, the silicone polymer can be an ultra-high molecular weight silicone. In general, the UHMW-Si can have an average molecular weight of greater than 100,000 g/mol, such as greater than about 200,000 g/mol, such as greater than about 300,000 g/mol, such as greater than about 500,000 g/mol and less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si can have a kinematic viscosity at 40° C. measured according to DIN 51562 of greater than 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

The UHMW-Silicone may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsiloxane, a polysilsesquioxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth(acryloyl) group in the end or main chain of the molecule. The UHMW-Si compounds may be used singly or in combination. Any of the above UHMW-Si compounds may be used with the above molecular weight and/or kinematic viscosity requirements.

As described above, in one embodiment, the polymer composition can contain a silicone polymer in combination with a second electrical resistance agent. The second electrical resistance agent can be a polyester elastomer. In one aspect, the silicone polymer and the polyester elastomer can be compounded together to form a masterbatch prior to being combined with the other components. The polyester elastomer, for instance, can be a copolyester polymer. For example, the copolyester polymer can be a segmented thermoplastic copolyester, such as a multi-block copolymer.

When added together, the silicone polymer and the polyester elastomer can be present in the polymer composition at a weight ratio of from about 3:1 to about 1:3. The weight ratio, for instance, can be from about 2:1 to about 1:1.5. The silicone polymer can be present in the polymer composition generally in an amount from about 0.3% by weight to about 5% by weight. For instance, the silicone polymer can be present in the polymer composition in an amount greater than about 1.3% by weight, such as in an amount greater than about 1.5% by weight, such as in an amount greater than about 1.7% by weight, such as in an amount greater than about 2% by weight, such as in an amount greater than about 2.2% by weight, such as in an amount greater than about 2.4% by weight, and generally in an amount less than about 4.5% by weight.

In an alternative embodiment, a polyester elastomer is added to the polymer composition as an electrical resistance agent without also adding a silicone polymer.

The thermoplastic polyester elastomer can be, for instance, a thermoplastic copolyester elastomer that comprises a thermoplastic ester ether elastomer. In one aspect, the thermoplastic polyester elastomer can be a thermoplastic copolyester elastomer that comprises a block copolymer of polybutylene terephthalate and polyether segments.

In one embodiment, the polymer composition may contain a segmented thermoplastic copolyester. The thermoplastic polyester elastomer, for example, may comprise a multi-block copolymer. Useful segmented thermoplastic copolyester elastomers include a multiplicity of recurring long chain ester units and short chain ester units joined head to tail through ester linkages. The long chain units can be represented by the formula

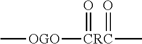

and the short chain units can be represented by the formula

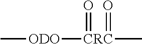

where G is a divalent radical remaining after the removal of the terminal hydroxyl groups from a long chain polymeric glycol having a number average molecular weight in the range from about 600 to 6,000 and a melting point below about 55° C., R is a hydrocarbon radical remaining after removal of the carboxyl groups from dicarboxylic acid having a molecular weight less than about 300, and D is a divalent radical remaining after removal of hydroxyl groups from low molecular weight diols having a molecular weight less than about 250.

The short chain ester units in the copolyetherester provide about 15 to 95% of the weight of the copolyetherester, and about 50 to 100% of the short chain ester units in the copolyetherester are identical.

The term “long chain ester units” refers to the reaction product of a long chain glycol with a dicarboxylic acid. The long chain glycols are polymeric glycols having terminal (or nearly terminal as possible) hydroxy groups, a molecular weight above about 600, such as from about 600-6000, a melting point less than about 55° C. and a carbon to oxygen ratio about 2.0 or greater. The long chain glycols are generally poly(alkylene oxide) glycols or glycol esters of poly(alkylene oxide) dicarboxylic acids. Any substituent groups can be present which do not interfere with polymerization of the compound with glycol(s) or dicarboxylic acid(s), as the case may be. The hydroxy functional groups of the long chain glycols which react to form the copolyesters can be terminal groups to the extent possible. The terminal hydroxy groups can be placed on end capping glycol units different from the chain, i.e., ethylene oxide end groups on poly(propylene oxide glycol).

The term “short chain ester units” refers to low molecular weight compounds or polymer chain units having molecular weights less than about 550. They are made by reacting a low molecular weight diol (below about 250) with a dicarboxylic acid.

The dicarboxylic acids may include the condensation polymerization equivalents of dicarboxylic acids, that is, their esters or ester-forming derivatives such as acid chlorides and anhydrides, or other derivatives which behave substantially like dicarboxylic acids in a polymerization reaction with a glycol.

The dicarboxylic acid monomers for the elastomer have a molecular weight less than about 300. They can be aromatic, aliphatic or cycloaliphatic. The dicarboxylic acids can contain any substituent groups or combination thereof which do not interfere with the polymerization reaction. Representative dicarboxylic acids include terephthalic and isophthalic acids, bibenzoic acid, substituted dicarboxy compounds with benzene nuclei such as bis(p-carboxyphenyl) methane, p-oxy-(p-carboxyphenyl) benzoic acid, ethylene-bis(p-oxybenzoic acid), 1,5-naphthalene dicarboxylic acid, 2,6-naphthalene dicarboxylic acid, 2,7-naphthalene dicarboxylic acid, phenanthralenedicarboxylic acid, anthralenedicarboxylic acid, 4,4′-sulfonyl dibenzoic acid, etc. and C₁-C₁₀ alkyl and other ring substitution derivatives thereof such as halo, alkoxy or aryl derivatives. Hydroxy acids such as p(β-hydroxyethoxy) benzoic acid can also be used providing an aromatic dicarboxylic acid is also present.

Representative aliphatic and cycloaliphatic acids are sebacic acid, 1,3-or 1,4-cyclohexane dicarboxylic acid, adipic acid, glutaric acid, succinic acid, carbonic acid, oxalic acid, itaconic acid, azelaic acid, diethylmalonic acid, fumaric acid, citraconic acid, allylmalonate acid, 4-cyclohexene-1,2-dicarboxylate acid, pimelic acid, suberic acid, 2,5-diethyladipic acid, 2-ethylsuberic acid, 2,2,3,3-tetramethylsuccinic acid, cyclopentanedicarboxylic acid, decahydro-1,5-(or 2,6-) naphthylenedicarboxylic acid, 4,4′-bicyclohexyl dicarboxylic acid, 4,4′-methylenebis(cyclohexyl carboxylic acid), 3,4-furan dicarboxylate, and 1,1-cyclobutane dicarboxylate.

The dicarboxylic acid may have a molecular weight less than about 300. In one embodiment, phenylene dicarboxylic acids are used such as terephthalic and isophthalic acid.

Included among the low molecular weight (less than about 250) diols which react to form short chain ester units of the copolyesters are acyclic, alicyclic and aromatic dihydroxy compounds. Included are diols with 2-15 carbon atoms such as ethylene, propylene, isobutylene, tetramethylene, pentamethylene, 2,2-dimethyltrimethylene, hexamethylene and decamethylene glycols, dihydroxy cyclohexane, cyclohexane dimethanol, resorcinol, hydroquinone, 1,5-dihydroxy naphthalene, etc. Also included are aliphatic diols containing 2-8 carbon atoms. Included among the bis-phenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol). Low molecular weight diols also include such equivalent ester-forming derivatives.

Long chain glycols which can be used in preparing the polymers include the poly(alkylene oxide) glycols such as polyethylene glycol, poly(1,2- and 1,3-propylene oxide) glycol, poly(tetramethylene oxide) glycol, poly(pentamethylene oxide) glycol, poly(hexamethylene oxide) glycol, poly(heptamethylene oxide) glycol, poly(octamethylene oxide) glycol, poly(nonamethylene oxide) glycol and poly(1,2-butylene oxide) glycol; random and block copolymers of ethylene oxide and 1,2-propylene oxide and poly-formals prepared by reacting formaldehyde with glycols, such as pentamethylene glycol, or mixtures of glycols, such as a mixture of tetramethylene and pentamethylene glycols.

In addition, the dicarboxymethyl acids of poly(alkylene oxides) such as the one derived from polytetramethylene oxide HOOCCH₂(OCH₂CH₂CH₂CH₂)ₓOCH₂COOH IV can be used to form long chain glycols in situ. Polythioether glycols and polyester glycols also provide useful products. In using polyester glycols, care must generally be exercised to control a tendency to interchange during melt polymerization, but certain sterically hindered polyesters, e.g., poly(2,2-dimethyl-1,3-propylene adipate), poly(2,2-dimethyl-1,3-propylene/2-methyl-2-ethyl-1,3-propylene 2,5-dimethylterephthalate), poly(2,2-dimethyl-1,3-propylene/2,2-diethyl-1,3-propylene, 1,4 cyclohexanedicarboxylate) and poly(1,2-cyclohexylenedimethylene/2,2-dimethyl-1,3-propylene 1,4-cyclohexanedicarboxylate) can be utilized under normal reaction conditions and other more reactive polyester glycols can be used if a short residence time is employed. Either polybutadiene or polyisoprene glycols, copolymers of these and saturated hydrogenation products of these materials are also satisfactory long chain polymeric glycols. In addition, the glycol esters of dicarboxylic acids formed by oxidation of polyisobutylenediene copolymers are useful raw materials.

Although the long chain dicarboxylic acids (IV) above can be added to the polymerization reaction mixture as acids, they react with the low molecular weight diols(s) present, these always being in excess, to form the corresponding poly(alkylene oxide) ester glycols which then polymerize to form the G units in the polymer chain, these particular G units having the structure

-DOCCH₂(OCH₂CH₂CH₂CH₂)OCH₂COOD0

when only one low molecular weight diol (corresponding to D) is employed. When more than one diol is used, there can be a different diol cap at each end of the polymer chain units. Such dicarboxylic acids may also react with long chain glycols if they are present, in which case a material is obtained having a formula the same as V above except the Ds are replaced with polymeric residues of the long chain glycols. The extent to which this reaction occurs is quite small, however, since the low molecular weight diol is present in considerable molar excess.

In place of a single low molecular weight diol, a mixture of such diols can be used. In place of a single long chain glycol or equivalent, a mixture of such compounds can be utilized, and in place of a single low molecular weight dicarboxylic acid or its equivalent, a mixture of two or more can be used in preparing the thermoplastic copolyester elastomers which can be employed in the compositions of this invention. Thus, the letter “G” in Formula II above can represent the residue of a single long chain glycol or the residue of several different glycols, the letter D in Formula III can represent the residue of one or several low molecular weight diols and the letter R in Formulas II and Ill can represent the residue of one or several dicarboxylic acids. When an aliphatic acid is used which contains a mixture of geometric isomers, such as the cis-trans isomers of cyclohexane dicarboxylic acid, the different isomers should be considered as different compounds forming different short chain ester units with the same diol in the copolyesters. The copolyester elastomer can be made by conventional ester interchange reaction.

Copolyether esters with alternating, random-length sequences of either long chain or short chain oxyalkylene glycols can contain repeating high melting blocks that are capable of crystallization and substantially amorphous blocks with a relatively low glass transition temperature. In one embodiment, the hard segments can be composed of tetramethylene terephthalate units and the soft segments may be derived from aliphatic polyether and polyester glycols. Of particular advantage, the above materials resist deformation at surface temperatures because of the presence of a network of microcrystallites formed by partial crystallization of the hard segments. The ratio of hard to soft segments determines the characteristics of the material. Thus, another advantage to thermoplastic polyester elastomers is that soft elastomers and hard elastoplastics can be produced by changing the ratio of the hard and soft segments.

In one particular embodiment, the polyester thermoplastic elastomer has the following formula: −[4GT]ₓ[BT]_{y}, wherein 4G is butylene glycol, such as 1,4-butane diol, B is poly(tetramethylene ether glycol) and T is terephthalate, and wherein x is from about 0.60 to about 0.99 and y is from about 0.01 to about 0.40.

In one aspect, the thermoplastic polyester elastomer can be a block copolymer of polybutylene terephthalate and polyether segments and can have a structure as follows:

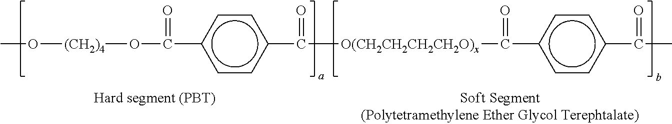

wherein a and b are integers and can vary from 2 to 10,000. The ratio between hard and soft segments in the block copolymer as described above can be varied in order to vary the properties of the elastomer. In one aspect, the density of the polyester elastomer as indicated above can be from about 1.05 g/cm³ to about 1.15 g/cm³, such as from about 1.08 g/cm³ to about 1.1 g/cm³.

In an alternative embodiment, the electrical resistance agent may comprise a non-aromatic polymer, which refers to a polymer that does not include any aromatic groups on the backbone of the polymer. Such polymers include acrylate polymers and/or graft copolymers containing an olefin. For instance, an olefin polymer can serve as a graft base and can be grafted to at least one vinyl polymer or one ether polymer. In still another embodiment, the graft copolymer can have an elastomeric core based on polydienes and a hard or soft graft envelope composed of a (meth)acrylate and/or a (meth)acrylonitrile.

Examples of electrical resistance agents as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, the electrical resistance agent can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The electrical resistance agent may be a linear or branched, homopolymer or copolymer (e.g., random, graft, block, etc.) containing epoxy functionalization, e.g., terminal epoxy groups, skeletal oxirane units, and/or pendent epoxy groups. For instance, the electrical resistance modifier may be a copolymer including at least one monomer component that includes epoxy functionalization. The monomer units of the electrical resistance agent may vary. For example, the electrical resistance agent can include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers as may be incorporated in the electrical resistance agent may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the electrical resistance agent can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the electrical resistance agent can be a terpolymer that includes epoxy functionalization. For instance, the electrical resistance agent can include a methacrylic component that includes epoxy functionalization, an α-olefin component, and a methacrylic component that does not include epoxy functionalization. For example, the electrical resistance agent may be poly(ethylene-co-methylacrylate-co-glycidyl methacrylate), which has the following structure:

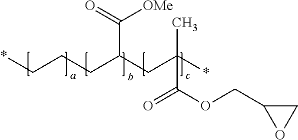

wherein, a, b, and c are 1 or greater.

In another embodiment the electrical resistance agent can be a random copolymer of ethylene, ethyl acrylate and maleic anhydride having the following structure:

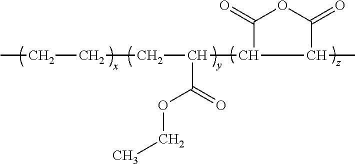

wherein x, y and z are 1 or greater.

The relative proportion of the various monomer components of a copolymeric electrical resistance agent is not particularly limited. For instance, in one embodiment, the epoxy-functional methacrylic monomer components can form from about 1 wt. % to about 25 wt. %, or from about 2 wt. % to about 20 wt % of a copolymeric electrical resistance agent. An α-olefin monomer can form from about 55 wt. % to about 95 wt. %, or from about 60 wt. % to about 90 wt. %, of a copolymeric electrical resistance agent. When employed, other monomeric components (e.g., a non-epoxy functional methacrylic monomers) may constitute from about 5 wt. % to about 35 wt. %, or from about 8 wt. % to about 30 wt. %, of a copolymeric electrical resistance agent.

The molecular weight of the above electrical resistance agent can vary widely. For example, the electrical resistance agent can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

One or more polyester elastomers and/or methacrylate butadiene styrene polymers can be present in the polymer composition generally in an amount from about 0.3% to about 7% by weight including all increments of 0.1% therebetween. For example, one or more polyester elastomers can be present in the polymer composition (without any other electrical resistance agents) in an amount generally greater than about 1% by weight, such as in an amount greater than about 1.5% by weight, such as in an amount greater than about 2% by weight, such as in an amount greater than about 2.5% by weight, such as in an amount greater than about 3% by weight, and generally in an amount less than about 10% by weight, such as in an amount less than about 8% by weight, such as in an amount less than about 6% by weight.

In one embodiment, a polyester elastomer can be present in the polymer composition in combination with a methyl methacrylate butadiene styrene polymer at a weight ratio of from about 3:1 to about 1:3, such as from about 2:1 to about 1:2. The polyester elastomer and the methyl methacrylate butadiene styrene copolymer can each be present in the polymer composition generally in an amount from about 0.3% by weight to about 6% by weight, such as from about 0.5% by weight to about 2.5% by weight.

The polymer composition can also contain an organometallic compatibilizer. The organometallic compatibilizer has been found to unexpectedly increase hydrolysis resistance and improve the flow properties of the polymer composition during polymer processing. In addition, the organometallic compatibilizer can provide various other benefits and advantages. For instance, the organometallic compatibilizer can provide anti-corrosion properties, increase the acid resistance of the polymer composition, and can improve the long-term aging properties of the polymer composition. In addition, the organometallic compatibilizer can serve as an intumescent flame retardant in certain applications.

The organometallic compatibilizer may comprise a monoalkoxy titanate. Other organometallic compounds that may be used include zirconates and aluminates. Specific examples of titanates that may be incorporated into the polymer composition include Titanium IV 2-propanolato, tris isooctadecanoato-O; Titanium IV bis 2-methyl-2-propenoato-O, isooctadecanoato-O 2-propanolato; Titanium IV 2-propanolato, tris(dodecyl)benzenesulfanato-O; Titanium IV 2-propanolato, tris(dioctyl)phosphato-O; Titanium IV, tris(2-methyl)-2-propenoato-O, methoxydiglycolylato; Titanium IV 2-propanolato, tris(dioctyl)pyrophosphato-O; Titanium IV, tris(2-propenoato-O), methoxydiglycolylato-O; Titanium IV 2-propanolato, tris(3,6-diaza)hexanolato, and mixtures thereof.

When present in the polymer composition, the organometallic compatibilizer can be included in an amount of generally greater than about 0.05% by weight, such as greater than about 0.1% by weight, such as greater than about 0.2% by weight, such as greater than about 0.28% by weight, and generally less than about 2.8% by weight, such as less than about 2.5% by weight, such as less than about 2.2% by weight, such as less than about 1.8% by weight, such as less than about 1.6% by weight, such as less than about 0.7% by weight.

In one embodiment, the polymer composition of the present disclosure can contain a carbodiimide compound. The carbodiimide compound can have a carbodiimide group (—N═C═N—) in the molecule. The carbodiimide compound can provide hydrolysis resistance, especially in relation to epoxy-based compounds. In addition, the carbodiimide compound works well with the flame retardant additives. Applicable carbodiimide compounds include an aliphatic carbodiimide compound having an aliphatic main chain, an alicyclic carbodiimide compound having an alicyclic main chain, and an aromatic carbodiimide compound having an aromatic main chain. An aromatic carbodiimide compound may provide greater resistance to hydrolysis.

Examples of the aliphatic carbodiimide compound include diisopropyl carbodiimide, dioctyldecyl carbodiimide, or the like. An example of the alicyclic carbodiimide compound includes dicyclohexyl carbodiimide, or the like.

Examples of aromatic carbodiimide compound include: a mono- or di-carbodiimide compound such as diphenyl carbodiimide, di-2,6-dimethylphenyl carbodiimide, N-tolyl-N′-phenyl carbodiimide, di-p-nitrophenyl carbodiimide, di-p-aminophenyl carbodiimide, di-p-hydroxyphenyl carbodiimide, di-p-chlorophenyl carbodiimide, di-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-tolyl carbodiimide, p-phenylene-bis-dicyclohexyl carbodiimide, p-phenylene-bis-di-p-chlorophenyl carbodiimide or ethylene-bis-diphenyl carbodiimide; and a polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(1-methyl-3,5-diisopropylphenylene carbodiimide), poly(1,3,5-triethylphenylene carbodiimide) or poly(triisopropylphenylene carbodiimide). These compounds can be used in combination of two or more of them. Among these, specifically preferred ones to be used are di-2,6-dimethylphenyl carbodiimide, poly(4,4′-diphenylmethane carbodiimide), poly(phenylene carbodiimide), and poly(triisopropylphenylene carbodiimide).

In one aspect, the carbodiimide compound is a polycarbodiimide. For instance, the polycarbodiimide can have a weight average molecular weight of about 10,000 g/mol or greater and generally less than about 100,000 g/mol. Examples of polycarbodiimides include Stabaxol KE9193 and Stabaxol P100 by Lanxess and Lubio AS3-SP by Schaeffe Additive Systems.

The carbodiimide compound can be present in the polymer composition in an amount greater than about 0.3% by weight, such as in an amount greater than about 0.8% by weight, and generally in an amount less than about 4% by weight, such as in an amount less than about 3% by weight, such as in an amount less than about 1.8% by weight.

The thermoplastic polymer composition of the present invention may also include a lubricant that constitutes from about 0.01 wt. % to about 2 wt. %, in some embodiments from about 0.1 wt. % to about 1 wt. %, and in some embodiments, from about 0.2 wt. % to about 0.5 wt. % of the polymer composition. The lubricant may be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt. Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Such fatty acid salts generally have an acid value (ASTM D 1386) of about 20 mg KOH/g or less, in some embodiments about 18 mg KOH/g or less, and in some embodiments, from about 1 to about 15 mg KOH/g. Particularly suitable fatty acid salts for use in the present invention are derived from crude montan wax, which contains straight-chain, unbranched monocarboxylic acids with a chain length in the range of C₂₈-C₃₂. Such montanic acid salts are commercially available from Clariant GmbH under the designations Licomont® CaV 102 (calcium salt of long-chain, linear montanic acids) and Licomont® NaV 101 (sodium salt of long-chain, linear montanic acids).

If desired, fatty acid esters may be used as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. Licowax® OP (Clariant), for instance, contains montanic acids partially esterified with butylene glycol and montanic acids partially saponified with calcium hydroxide. Thus, Licowax® OP contains a mixture of montanic acid esters and calcium montanate. Other montanic acid esters that may be employed include Licowax® E, Licowax® OP, and Licolub® WE 4 (all from Clariant), for instance, are montanic esters obtained as secondary products from the oxidative refining of raw montan wax. Licowax® E and Licolub® WE 4 contain montanic acids esterified with ethylene glycol or glycerine.

Other known waxes may also be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin® 220 and Paricin® 285, respectively.

The polymer composition may also contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

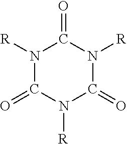

wherein, each R is independently a phenolic group, which may be attached to the triazine ring via a C₁ to C₅ alkyl or an ester substituent. Preferably, each R is one of the following formula (I)-(III):

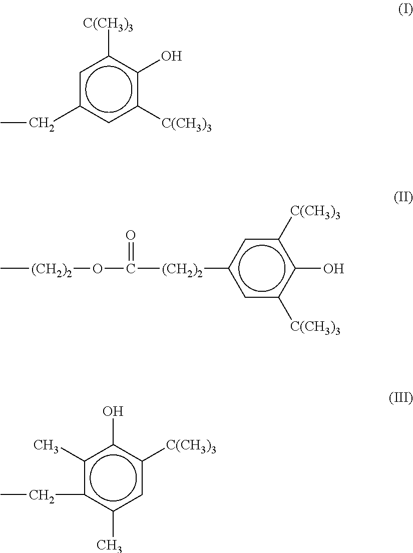

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each P group is represented by the Formula II).

Sterically hindered phenolic antioxidants may constitute from about 0.01 wt. % to about 3 wt. %, in some embodiments from about 0.05 wt. % to about 1 wt, %, and in some embodiments, from about 0.05 wt. % to about 0.3 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

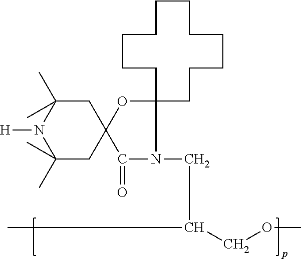

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

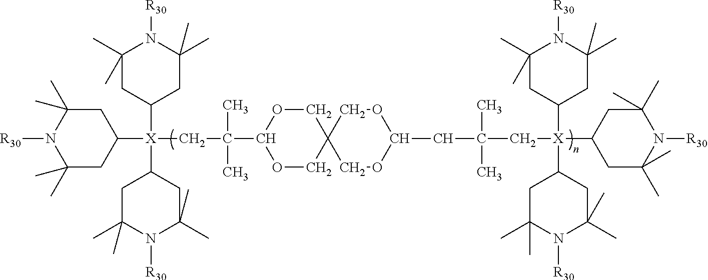

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB®@ LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

In one embodiment, the polymer composition may contain a blend of stabilizers that produce ultraviolet resistance and color stability. The combination of stabilizers may allow for products to be produced that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

Organophosphorus compounds may be employed in the composition that serve as secondary antioxidants to decompose peroxides and hydroperoxides into stable, non-radical products. Trivalent organophosphorous compounds (e.g., phosphites or phosphonites) are particularly useful in the stabilizing system of the present invention. Monophosphite compounds (i.e., only one phosphorus atom per molecule) may be employed in certain embodiments of the present invention. Preferred monophosphites are aryl monophosphites contain C₁ to C₁₀ alkyl substituents on at least one of the aryloxide groups. These substituents may be linear (as in the case of nonyl substituents) or branched (such as isopropyl or tertiary butyl substituents). Non-limiting examples of suitable aryl monophosphites (or monophosphonites) may include triphenyl phosphite; diphenyl alkyl phosphites; phenyl dialkyl phosphites; tris(nonylphenyl) phosphite (Weston™ 399, available from GE Specialty Chemicals); tris(2,4-di-tert-butylphenyl) phosphite (Irgafos®168, available from Ciba Specialty Chemicals Corp.); bis(2,4-di-tert-butyl-6-methylphenyl)ethyl phosphite (Irgafos® 38, available from Ciba Specialty Chemicals Corp.): and 2,2′,2″-nitrilo[triethyltris(3,3′5,5′-tetra-tert-butyl-1,1′-biphenyl-2,2′-diyl) phosphate (Irgafos® 12, available from Ciba Specialty Chemicals Corp.). Aryl diphosphites or diphosphonites (i.e., contains at least two phosphorus atoms per phosphite molecule may also be employed in the stabilizing system and may include, for instance, distearyl pentaerythritol diphosphite, diisodecyl pentaerythritol diphosphite, bis(2,4 di-tert-butylphenyl) pentaerythritol diphosphite (Irgafos 126 available from Ciba); bis(2,6-di-tert-butyl-4-methylpenyl)pentaerythritol diphosphite; bisisodecyloxypentaerythritol diphosphite, bis(2,4-di-tert-butyl-6-methylphenyl)pentaerythritol diphosphite, bis(2,4,6-tri-tert-butylphenyl)pentaerythritol diphosphite, tetrakis(2,4-di-tert-butylphenyl)4,4′-biphenylene-diphosphonite (Sandostab™ P-EPQ, available from Clariant) and bis(2,4-dicumylphenyl)pentaerythritol diphosphite (Doverphos® S-9228).

Organophosphorous compounds may constitute from about 0.01 wt. % to about 2 wt. %, in some embodiments from about 0.05 wt. % to about 1 wt. %, and in some embodiments, from about 0.1 wt. % to about 0.5 wt. % of the polymer composition.

In addition to those mentioned above, secondary amines may also be employed in the composition. The secondary amines may be aromatic in nature, such as N-phenyl naphthylamines (e.g., Naugard® PAN from Uniroyal Chemical); diphenylamines, such as 4,4′-bis(dimethylbenzyl)-diphenylamine (e.g., Naugard®445 from Uniroyal Chemical); p-phenylenediamines (e.g., Wingstay® 300 from Goodyear); quinolones, and so forth. Particularly suitable secondary amines are oligomeric or polymeric amines, such as homo- or copolymerized polyamides. Examples of such polyamides may include nylon 3 (poly-β-alanine), nylon 6, nylon 10, nylon 11, nylon 12, nylon 6/6, nylon 6/9, nylon 6/10, nylon 6/11, nylon 6/12, polyesteramide, polyamideimide, polyacrylamide, and so forth. In one particular embodiment, the amine is a polyamide terpolymer having a melting point in the range from 120° C., to 220° C. Suitable terpolymers may be based on the nylons selected from the group consisting of nylon 6, nylon 6/6, nylon 6/9, nylon 6/10 and nylon 6/12, and may include nylon 6-66-69; nylon 6-66-610 and nylon 6-66-612. One example of such a nylon terpolymer is a terpolymer of nylon 6-66-610 and is commercially available from Du Pont de Nemours under the designation Elvamide® 8063R. Secondary amines may constitute from about 0.01 wt. % to about 2 wt. %, of the entire polymer composition.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include various other polymer-soluble dyes. The colorants can generally be present in the composition in an amount up to about 2 percent by weight.

To help achieve excellent resistivity values, the composition can be generally free of conventional materials having a high degree of electrical conductivity. For example, the polymer composition may be generally free of electrically conductive fillers having an intrinsic volume resistivity of less than about 1 ohm-cm, in some embodiments about less than about 0.1 ohm-cm, and in some embodiments, from about 1×10⁻⁸ to about 1×10⁻² ohm-cm, such as determined at a temperature of about 20° C. Examples of such electrically conductive fillers may include, for instance, electrically conductive carbon materials such as, graphite, electrically conductive carbon black, carbon fibers, graphene, carbon nanotubes, etc.; metals (e.g., metal particles, metal flakes, metal fibers, etc.); ionic liquids; and so forth. While it is normally desired to minimize the presence of such electrically conductive materials, they may nevertheless be present in a relatively small percentage in certain embodiments, such as in an amount of about 5 wt. % or less, in some embodiments about 2 wt. % or less, in some embodiments about 1 wt. % or less, in some embodiments about 0.5 wt. % or less, and in some embodiments, from about 0.001 wt. % to about 0.2 wt. % of the polymer composition.

The compositions of the present disclosure can be compounded and formed into polymer articles using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 150 to 300° C., such as from 200 to 280° C., such as from 220 to 270° C. or 240 to 260° C. However, such processing should be conducted for each respective composition at a desired temperature to minimize any polymer degradation.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

Polymer compositions in accordance with the present disclosure can have excellent flame resistant properties in addition to physical properties. For instance, when tested according to Underwriters Laboratories Test 94 according to the Vertical Burn Test, test plaques made according to the present disclosure can have a UL-94 rating of V-0, even when tested at a thickness of 1.5 mm or even at a thickness of 0.8 mm.

Of particular advantage, flame resistant polymer compositions can be formulated in accordance with the present disclosure with excellent flow properties. For example, when tested according to ISO Test 1133 at a temperature of 250° C. and at a load 2.16 kg, the overall polymer composition can have a melt flow rate of greater than about 3 cm³/10 min, such as greater than about 4 cm³/10 min, such as greater than about 5 cm³/10 min, such as greater than about 6 cm³/10 min, such as greater than about 7 cm³/10 min, such as greater than about 8 cm³/10 min, such as greater than about 9 cm³/10 min, such as greater than about 10 cm³/10 min. The melt flow rate is generally less than about 50 cm³/10 min.

The present disclosure may be better understood with reference to the following examples.

Various polymer compositions were formulated in accordance with the present disclosure and tested for various properties. The following results were obtained.

TABLE 1

| | Norm | | | | | | | | |
|---|---|---|---|---|---|---|---|---|---|
| Formulation | ISO | Unit | 1 | 2 | 3 | 4 | 5 | 6 | 7 |
| Polybutylene Terephthalate | | % | 51.5 | 48.5 | 48.5 | 47.5 | 46.5 | 48.0 | 48.5 |
| (MVR40 cm³/10 min) (<20 | | | | | | | | | |
| mmol COOH/kg) | | | | | | | | | |
| Polybutylene Terephthalate | | % | 1.5 | 1.5 | 1.5 | 1.5 | 1.5 | 1.5 | 1.5 |
| (blending aid) | | | | | | | | | |
| Glass fibers with sizing | | % | 25.0 | 25.0 | 25.0 | 25.0 | 25.0 | 25.0 | 25.0 |
| composition containing | | | | | | | | | |
| hydrolysis resistant agent | | | | | | | | | |
| Aluminum phosphite and | | % | 13.3 | 13.3 | 13.3 | 13.3 | 15.0 | 13.3 | 13.3 |
| Aluminum diethyl phosphinate | | | | | | | | | |
| blend | | | | | | | | | |
| Melamine cyanurate | | % | 6.7 | 6.7 | 6.7 | 6.7 | 6.7 | 6.7 | 6.7 |
| Pentaerythritol tetrakis(Beta- | | % | 0.1 | 0.1 | 0.1 | 0.1 | 0.1 | 0.1 | 0.1 |
| Laurylthiopropionate) | | | | | | | | | |
| Pentaerythritol tetrakis(3-(3,5- | | % | 0.1 | 0.1 | 0.1 | 0.1 | 0.1 | 0.1 | 0.1 |
| di-tert-butyl-4- | | | | | | | | | |
| hydroxyphenyl) propionate) | | | | | | | | | |
| Bis-(2, 4-di-t-butylphenol) | | % | 0.2 | 0.2 | 0.2 | 0.2 | 0.2 | 0.2 | 0.2 |
| Pentaerythritol Diphosphite | | | | | | | | | |
| Montanic acid triol ester | | % | 0.3 | 0.3 | 0.3 | 0.3 | 0.3 | 0.3 | 0.3 |
| Titanate coupling agent | | % | 0.3 | 0.3 | 0.3 | 0.3 | 0.3 | 0.3 | 0.3 |
| Polycarbodiimide | | % | 1.0 | 1.0 | 1.0 | 1.0 | 1.0 | 1.0 | 1.0 |
| Polybutylene terephthalate | | % | 0 | 0 | 3.0 | 4.0 | 0 | 0 | 0 |
| and elastomer | | | | | | | | | |
| Copolyester elastomer with | | % | 0 | 1.5 | 0 | 0 | 0 | 0 | 0 |
| ether and ester units | | | | | | | | | |
| UHMW Si and copolyester | | % | 0 | 0 | 0 | 0 | 4.0 | 3.5 | 3.0 |
| elastomer (1:1 ratio) | | | | | | | | | |
| Methyl methacrylate- | | % | 0 | 1.5 | 0 | 0 | 0 | 0 | 0 |
| butadiene-styrene copolymer | | | | | | | | | |
| Total | | % | 100 | 100 | 100 | 100 | 100 | 100 | 100 |
| MVR 250° C./5 kg | 1133 | cm³/10 | 7 | 6 | 7 | 8 | 4 | 5 | 5.5 |
| | | min | | | | | | | |
| Vertical Burning (1.6 mm) | UL94 | Rating | V0 | V0 | V0 | V0 | V0 | V0 | V0 |
| Vertical Burning (0.8 mm) | UL94 | Rating | V0 | V0 | V0 | V1 | V1 | V1 | V1 |
| CTI | IEC | V | 475 | 550 | 500 | 525 | 600 | 575 | 600 |
| | 60112 | | | | | | | | |

The titanate coupling agent used was titanium IV 2-propanolato,tris(dioctyl)phosphato-O.

The above formulations were molded into test samples and subjected to the Hydrolysis Test. During the Hydrolysis Test, a sample was placed in a pressure cooker at 121° C. for 96 hours. The initial mechanical properties of the sample was then compared to samples that were subjected to the Hydrolysis Test at the different time intervals. The following results were obtained:

TABLE 2

| Property | | | | | | | | | | | | | | | |
|---|---|---|---|---|---|---|---|---|---|---|---|---|---|---|---|
| before | | | | | | | | | | | | | | | |
| storage | | | | | | | | | | | | | | | |
| and after | | | | | | | | | | | | | | | |
| storage | | | | | | | | | | | | | | | |
| at | | | | | | | | | | | | | | | |
| 121° C. | | | | | | | | | | | | | | | |
| for | | | | | | | | | | | | | | | |
| 96 in a | | | | | | | | | | | | | | | |
| pressure | | | % | | % | | % | | % | | % | | % | | % |
| cooker | Unit | 1 | retention | 2 | retention | 3 | retention | 4 | retention | 5 | retention | 6 | retention | 7 | retention |
| Tensile | MPa | 11300 | 100% | 9617 | 100% | 9923 | 100% | 9840 | 100% | 8949 | 100% | 9158 | 100% | 9287 | 100% |
| Modulus | | | | | | | | | | | | | | | |
| Tensile | | 10400 | 92% | 8673 | 90% | 8880 | 89% | 8824 | 90% | 7820 | 87% | 8035 | 88% | 8100 | 87% |
| Modulus | | | | | | | | | | | | | | | |
| (96 h, | | | | | | | | | | | | | | | |
| 121° C.) | | | | | | | | | | | | | | | |
| Break | MPa | 115 | 100% | 109 | 100% | 114 | 100% | 113 | 100% | 96 | 100% | 103 | 100% | 102 | 100% |
| Stress | | | | | | | | | | | | | | | |
| Break | | 83 | 72% | 68 | 62% | 63.2 | 55% | 65 | 58% | 61 | 64% | 62 | 60% | 61 | 60% |
| Stress | | | | | | | | | | | | | | | |
| (96 h, | | | | | | | | | | | | | | | |
| 121° C.) | | | | | | | | | | | | | | | |
| Break | % | 2.1 | 100% | 2.4 | 100% | 2.4 | 100% | 2.4 | 100% | 2.3 | 100% | 2.5 | 100% | 2.4 | 100% |
| Strain | | | | | | | | | | | | | | | |
| Break | | 1.3 | 62% | 1.3 | 54% | 1.1 | 46% | 1.2 | 50% | 1.3 | 57% | 1.2 | 48% | 1.2 | 50% |
| Strain | | | | | | | | | | | | | | | |
| (96 h, | | | | | | | | | | | | | | | |
| 121° C.) | | | | | | | | | | | | | | | |
| Charpy | kJ/m² | 9 | | 9 | | 8 | | 9 | | 10 | | 10 | | 9 | |
| notched | | | | | | | | | | | | | | | |
| strength | | | | | | | | | | | | | | | |
| @ | | | | | | | | | | | | | | | |
| 23° C. | | | | | | | | | | | | | | | |

### Example 2

Various polymer compositions were formulated in accordance with the present disclosure and tested for various properties. The following results were obtained

TABLE 3

| Formulation | Norm ISO | Unit | 8 | 9 | 10 | 11 |
|---|---|---|---|---|---|---|
| Polybutylene | | % | 46.5 | 46.5 | 46.5 | 46.5 |
| Terephthalate | | | | | | |
| (MVR40 cm³/10 min) | | | | | | |
| (<20 mmol COOH/kg) | | | | | | |
| Polybutylene | | % | 1.5 | 1.5 | 1.5 | 1.5 |
| Terephthalate (blending | | | | | | |
| aid) | | | | | | |
| Glass fibers with sizing | | % | 25 | 25 | 25 | 25 |
| composition containing | | | | | | |
| hydrolysis resistant | | | | | | |
| agent | | | | | | |
| Aluminum phosphite | | % | 22 | 0 | 0 | 12 |
| and | | | | | | |
| Aluminum diethyl | | | | | | |
| phosphinate blend | | | | | | |
| Diethylphosphinate, | | % | 0 | 22 | 18 | 8.5 |
| Alumimum Salt (DEPAL) | | | | | | |
| Melamine cyanurate | | % | 0 | 0 | 4 | 1.5 |
| Pentaerythritol | | % | 0.1 | 0.1 | 0.1 | 0.1 |
| tetrakis(Beta- | | | | | | |
| Laurylthiopropionate) | | | | | | |
| Pentaerythritol tetrakis(3- | | % | 0.1 | 0.1 | 0.1 | 0.1 |
| (3,5-di-tert-butyl-4- | | | | | | |
| hydroxyphenyl)propiona | | | | | | |
| te) | | | | | | |
| Bis-(2, 4-di-t- | | % | 0.2 | 0.2 | 0.2 | 0.2 |
| butylphenol) | | | | | | |
| Pentaerythritol | | | | | | |
| Diphosphite | | | | | | |
| Montanicacid triol ester | | % | 0.3 | 0.3 | 0.3 | 0.3 |
| Titanate coupling agent | | % | 0.3 | 0.3 | 0.3 | 0.3 |
| Polycarbodiimide | | % | 1 | 1 | 1 | 1 |
| UHMWSiand | | % | 3 | 3 | 3 | 3 |
| co polyester | | | | | | |
| elastomer (1:1 ratio) | | | | | | |
| Total | | % | 100 | 100 | 100 | 100 |
| MVR 250° C./5 kg | 1133 | cm³/ | 13 | 4.5 | 5.1 | 8.7 |
| | | 10 | | | | |
| | | min | | | | |
| Vertical Burning (1.6 | UL94 | Rating | V1 | V0 | V0 | V0 |
| mm) | | | | | | |
| Vertical Burning (0.8 | UL94 | Rating | V1 | V1 | V0 | V0 |
| mm) | | | | | | |
| CTI | IEC | V | 600 | 600 | 600 | 600 |
| | 60112 | | | | | |

The titanate coupling agent used was titanium IV 2-propanolato,tris(dioctyl)phosphato-O.

The above formulations were molded into test samples and subjected to the Hydrolysis Test. During the Hydrolysis Test, a sample was placed in a pressure cooker at 121° C. for 96 hours. The initial mechanical properties of the sample was then compared to samples that were subjected to the Hydrolysis Test at the different time intervals. The following results were obtained:

TABLE 4

| Property | | | | | | | | | |
|---|---|---|---|---|---|---|---|---|---|
| before | | | | | | | | | |
| storage | | | | | | | | | |
| and after | | | | | | | | | |
| storage at | | | | | | | | | |
| 121° C. for | | | | | | | | | |
| 96 in a | | | | | | | | | |
| pressure | | | % | | % | | % | | % |
| cooker | Unit | 8 | retention | 9 | retention | 10 | retention | 11 | retention |
| Tensile | MPa | 9130 | 100% | 9115 | 100% | 9330 | 100% | 9190 | 100% |
| Modulus | | | | | | | | | |
| Tensile | | 8000 | 88% | 8100 | 89% | 8225 | 88% | 8080 | 88% |
| Modulus | | | | | | | | | |
| (96 h, | | | | | | | | | |
| 121° C.) | | | | | | | | | |
| Break | MPa | 98 | 100% | 93 | 100% | 95 | 100% | 98 | 100% |
| Stress | | | | | | | | | |
| Break | | 52 | 53% | 62 | 67% | 59 | 62% | 56 | 57% |
| Stress | | | | | | | | | |
| (96 h, | | | | | | | | | |
| 121° C.) | | | | | | | | | |
| Break | % | 2.5 | 100% | 2.3 | 100% | 2.3 | 100% | 2.3 | 100% |
| Strain | | | | | | | | | |
| Break | | 1 | 40% | 1.3 | 57% | 1.15 | 50% | 1.1 | 48% |
| Strain (96 h, | | | | | | | | | |
| 121° C.) | | | | | | | | | |
| Charpy | kJ/m² | 9 | | 8.6 | | 8.5 | | 8.4 | |
| notched | | | | | | | | | |
| strength @ | | | | | | | | | |
| 23°C | | | | | | | | | |
| Charpy | kJ/m² | 44 | | 40 | | 38 | | 44 | |
| unnotched | | | | | | | | | |
| strength @ | | | | | | | | | |
| 23° C. | | | | | | | | | |

The above samples demonstrate that excellent results can be obtained without including a phosphite and/or a nitrogen-containing synergist in the formulation.

### Example 3

A polymer composition was formulated in accordance with the present disclosure and tested for various properties. The following results were obtained.

TABLE 5

| Formulation | Unit | 12 |
|---|---|---|
| Polybutylene Terephthalate | % | 42.8 |
| (MVR40 cm³/10 min) | | |
| (<20 mmol COOH/kg) | | |
| Polybutylene Terephthalate | % | 1.5 |
| (blending aid) | | |
| Glass fibers with sizing | % | 30 |
| composition containing | | |
| Hydrolysis resistant agent | | |
| Melamine cyanurate | % | 6.0 |
| Diethylphosphinate, Aluminum | % | 15.0 |
| Salt (DEPAL) | | |
| Oligomeric Carbodiimide | % | 1.0 |
| Thioester | % | 0.1 |
| Monoalkoxy Titanate | % | 0.3 |
| Sterically Hindered Phenolic | % | 0.1 |
| Antioxidant | | |
| Diphosphite | % | 0.2 |
| UHMW Siloxane and copolyester | % | 3.0 |
| elastomer (1:1 ratio) | | |
| Total | % | 100 |
| MVR 250° C./5 kg | cm³/ | 7 |
| | 10 min | |
| Tensile modulus | MPa | 10,000 |
| Tensile strength | MPa | 115 |
| Strain at break | % | 2.2 |
| Charpy notched | kJ/m² | 8 |
| Charpy un-notched | kJ/m² | 47 |
| Vertical Burning (1.5 mm) | Rating | V0 |
| Vertical Burning (0.8 mm) | Rating | V0 |
| CTI | V | 475 |

[The above formulation was molded into test samples and subjected to the Hydrolysis Test. During the Hydrolysis Test, a sample was placed in a pressure cooker at 121° C. The sample was then evaluated after 96 and 168 hours. The initial mechanical properties of the sample were then compared to samples that were subjected to the Hydrolysis Test at different time intervals. The following results were obtained:

TABLE 6

| Property before storage | | % retention | % retention |
|---|---|---|---|
| and after storage at | Initial | after | after |
| 121° C. for variable | Property | 96 Storage | 168 Storage |
| hours in a pressure cooker | Value | Hours | Hours |
| Break Stress | 115 MPa | 74.5 | 74 |
| Break Strain | 2.2% | 65 | 65 |

The above composition possessed a dielectric strength of greater than 25 kV/mm over a temperature range of from 20° C. to 140° C., displayed a surface resistivity of greater than 1×10¹⁵ ohms over a temperature range of from 20° C. to 120° C., and displayed a volume resistivity of greater than 1×10¹⁵ ohm-cm over a temperature range of from 20° C. to 60° C.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a thermoplastic polymer, the thermoplastic polymer being present in the polymer composition in an amount greater than about 35% by weight;
a flame retardant composition contained within the polymer composition, the flame retardant composition comprising a non-halogen flame retardant;
reinforcing fibers dispersed throughout a polymer matrix formed from the thermoplastic polymer;
an electrical resistance agent comprising a silicone, a polyester elastomer, a methacrylate butadiene styrene, or mixtures thereof, the electrical resistance agent being present in the polymer composition in an amount less than about 10% by weight; and
wherein the polymer composition displays a comparative tracking index of at least 475 V.

2. A polymer composition as defined in claim 1, wherein the electrical resistance agent comprises an ultra-high molecular weight silicone and is present in the polymer composition in an amount from about 0.3% by weight to about 5% by weight.

3. A polymer composition as defined in claim 2, wherein the polymer composition comprises a second electrical resistance agent comprising a polyester elastomer and wherein the polyester elastomer comprises a copolyester elastomer, the ultra-high molecular weight silicone being present in the polymer composition in relation to the polyester elastomer at a weight ratio of from about 3:1 to about 1:3.

4. A polymer composition as defined in claim 1, wherein the thermoplastic polymer comprises a polyester polymer having carboxyl end groups in an amount less than about 20 mmol/kg.

5. A polymer composition as defined in claim 4, wherein the polyester polymer comprises a polybutylene terephthalate polymer.

6. A polymer composition as defined in claim 1, further comprising a polycarbodiimide.

7. A polymer composition as defined in claim 6, wherein the polycarbodiimide has a weight average molecular weight of 10,000 g/mol or greater.

8. A polymer composition as defined in claim 1, wherein the reinforcing fibers comprise glass fibers, and wherein the reinforcing fibers have an average fiber length of from about 1 mm to about 5 mm and have an average fiber diameter of from about 8 microns to about 12 microns.

9. A polymer composition as defined in claim 1, wherein the flame retardant composition comprises a metal phosphinate.

10. A flame resistant polymer composition as defined in claim 9, wherein the flame retardant composition further comprises a metal phosphite, wherein the metal phosphite comprises aluminum phosphite, wherein the metal phosphinate comprises an aluminum diethyl phosphinate.

11. A flame resistant polymer composition as defined in claim 9, wherein the flame retardant composition does not contain a metal phosphite.

12. A flame resistant polymer composition as defined in claim 9, wherein the flame retardant composition does not contain a nitrogen-containing synergist.

13. A flame resistant polymer composition as defined in claim 1, wherein the polymer composition further contains an organometallic compatibilizer.

14. A flame resistant polymer composition as defined in claim 13, wherein the organometallic compatibilizer comprises a titanate.

15. A flame resistant polymer composition as defined in claim 13, wherein the organometallic compatibilizer comprises titanium IV 2-propanolato,tris(dioctyl)phosphato-O.

16. A flame resistant polymer composition as defined in claim 1, wherein the polymer composition further contains an ester of a carboxylic acid and wherein the ester of the carboxylic acid comprises a reaction product of a montanic acid with a multi-functional alcohol.

17. A polymer composition as defined in claim 1, wherein when the polymer composition is subjected to the Hydrolysis Test at 121° C., a tensile modulus of the polymer composition reduces by no more than about 50% after 168 hours and a break strain of the polymer composition reduces by no more than about 45% after 168 hours.

18. An electrical connector that comprises at least two opposing walls between which a passageway is defined for receiving a contact element, the walls being formed from a polymer composition as defined in claim 1.

19. A polymer composition comprising:
a thermoplastic polymer, the thermoplastic polymer being present in the polymer composition in an amount greater than about 35% by weight;
a flame retardant composition contained within the polymer composition, the flame retardant composition comprising a non-halogen flame retardant;
reinforcing fibers dispersed throughout a polymer matrix formed from the thermoplastic polymer; and
wherein the polymer composition displays a comparative tracking index of at least 475 V, displays a dielectric strength of greater than about 15 kV/mm, displays a surface resistivity of greater than about 1×10¹⁴ ohms over a temperature range of from 20° C. to 120° C., displays a volume resistivity of greater than 1×10¹⁴ ohm-cm over a temperature range of from 20° C. to 60° C., and when the polymer composition is subjected to the Hydrolysis Test at 121° C., a break stress of the polymer composition reduces by no more than about 30% after 168 hours and a break strain of the polymer composition reduces by no more than about 40% after 168 hours.

20. A polymer composition as defined in claim 19, wherein the composition further comprises an electrical resistance agent comprising a silicone, a polyester elastomer, a methacrylate butadiene styrene, or mixtures thereof, the electrical resistance agent being present in the polymer composition in an amount less than about 10% by weight.

21. A polymer composition as defined in claim 19, wherein the polymer composition displays a dielectric strength of greater than about 25 kV/mm, displays a surface resistivity of greater than about 1×10¹⁵ ohms over a temperature range of from 20° C. to 120° C., and displays a volume resistivity of greater than 1×10¹⁵ ohm-cm over a temperature range of from 20° C. to 60° C.

22. A polymer composition as defined in claim 20, wherein the composition further comprises at least one antioxidant, an oligomeric carbodiimide, and a titanate.
